(19) United States
(12) Patent Application Publication
(10) Pub. No.: US 2019/0218823 A1
(43) Pub. Date: Jul. 18, 2019

(54) COMBINATION LOCK

(71) Applicant: Ming-Hsun Tsai, Tainan (TW)

(72) Inventor: Ming-Hsun Tsai, Tainan (TW)

(21) Appl. No.: 16/237,837

(22) Filed: Jan. 2, 2019

(30) Foreign Application Priority Data
Jan. 16, 2018 (TW) 107200712

(51) Int. Cl. E05B 37/02; E05B 73/00

(52) U.S. Cl. CPC E05B 37/025; E05B 71/00; E05B 73/0005

(57) ABSTRACT

Disclosed is a combination lock comprising: a lock body, a shackle, a combination assembly and a plurality of outer coverings, the combination assembly including a central slider and a plurality of combination disks, the plurality of combination disks being rotatable about and coaxially arranged on the central slider to determine whether the central slider is allowed to be moved to an unlocking position from a locking position such that locking or unlocking of the central slider is controlled according to a rotation position of the combination disks, the plurality of outer coverings being detachably mounted on external surfaces of the plurality of combination disks respectively, an outer surface of each outer covering being covered with an indicating marker, wherein the outer coverings are configured to be able to be detached from the external surfaces of the combination disks and be replaced by any other kinds of outer coverings having different indicating markers.

### FIELD OF THE INVENTION

The present invention relates to a locking device, and more particularly relates to a combination lock.

### BACKGROUND OF THE INVENTION

A combination lock, commonly used in a bicycle, warehouse, tool case, and the like, is a type of locking device which is operated between a locking state and an unlocking state by switching a sequence of numbers disposed on the combination lock. As shown in FIG. 8, one kind of the combination locks is a multi-dial type lock C0, which is provided with a plurality of rotating disks C1 disposed by surrounding a pin C2, whereas in FIG. 8, there are only two rotating disks C1 shown. An upper surface of each rotating disk is with a number area on which a plurality of numbers are sequentially arranged. In FIG. 8, the width of the number area is shown narrower in order to illustrate the inner structure thereof. The pin C2 is provided with a plurality of protruding teeth C21. Two neighboring protruding teeth C21 are provided with a notch. An inner surface of each rotating disk C1 is formed with a surrounding convex and a notch C11 between the surrounding convex. The surrounding convex of the rotating disk C1 rotates through the notch between two neighboring protruding teeth C21 when the rotating disk C1 rotates around the pin C2. When all of the notches C11 are aligned with all protruding teeth C21 in an axial direction of the pin, the pin C2 could move away from all rotating disks C1 in an axial direction of the pin C2 such that the combination lock is unlocked. If any notch C11 is not aligned with the protruding teeth C21 in an axial direction of the pin C2, the pin C2 could not be moved away from the rotating disks C1 in an axial direction of the pin C2 such that the combination lock C0 is locked. Only when all rotating disk C1 is rotated in a correct position, the combination lock C0 can be in the unlocking state.

In view of the above, each rotating disk of the combination lock is provided with a plurality of numbers on its surface. Each number is corresponding to a specific rotation position of the rotating disk. The rotating disks are rotated to their correct positions in relation to the pin on which specific numbers are indicated respectively in the unlocking state.

However, in a prior art, the rotating disk is non-replaceably disposed on the pin. A user could not determine the indicating form on the rotating disk other than digit form. The alternation of rotating disks is limited. Therefore, the conventional combination lock is necessary to be improved.

### SUMMARY OF THE INVENTION

Accordingly, one objective of the present invention is to provide a combination lock where the indicating form such as the form of numbers, symbols or other patterns on the rotating disk can be easily replaced.

In order to overcome the technical problems in prior art, the present invention provides a combination lock comprising: a lock body; a shackle, removably connected to the lock body; a combination assembly being assembled to move in relation to the lock body, the combination assembly including a central slider and a plurality of combination disks, the central slider being moved away from the lock body to lock the shackle or being gotten close to the lock body to unlock the shackle, the plurality of combination disks being rotatable about and coaxially arranged on the central slider to determine whether the central slider is allowed to be moved to an unlocking position from a locking position such that locking or unlocking of the central slider is controlled according to a rotation position of the combination disks; and a plurality of outer coverings being detachably mounted on external surfaces of the plurality of combination disks respectively, an outer surface of each outer covering being covered with an indicating marker, wherein the outer coverings are configured to be able to be detached from the external surfaces of the combination disks and be replaced by any other kinds of outer coverings having different indicating markers.

In one embodiment of the present invention, a combination lock is provided, wherein the outer covering is a ring body and is provided to rotate around the external surface of the combination disk.

In one embodiment of the present invention, a combination lock is provided, wherein each combination disk includes a fixing wheel and an outer wheel which is provided to rotate around an outer periphery of the fixing wheel.

In one embodiment of the present invention, a combination lock is provided, wherein an external wall of the outer wheel is formed with a plurality of external teeth, an internal wall of the outer covering is formed with a plurality of slots corresponding to the plurality of external teeth, and the plurality of external teeth being provided such that the outer covering is mounted on the outer wheel such that the outer covering engages the plurality of slots.

In one embodiment of the present invention, a combination lock is provided, wherein the lock body includes a front cap and a rear cap, the front cap being allocated in a backward direction along a longitudinal axis of the central slider in relation to the central slider to connect with the central slider, the rear cap being allocated in a forward direction along the longitudinal axis of the central slider in relation to the central slider to form a sleeve body having a sleeve, the sleeve body being extended from the rear cap, the sleeve is corresponding to the central slider, wherein the central slider slides through the sleeve along the longitudinal axis of the central slider to enable the front cap and the rear cap to be assembled together.

In one embodiment of the present invention, a combination lock is provided, wherein an external side of the sleeve body is axially formed with a groove, an internal periphery of the fixing wheel is formed with a convex having its shape corresponding to the groove and having its position corresponding to the groove, and the convex being contacted to the groove so as to limit a rotation of the fixing wheel in relation to the central slider.

In one embodiment of the present invention, a combination lock is provided, wherein the indicating marker of the outer covering includes a number indicating marker and/or a symbol indicating marker.

With the technical means adopted by the present invention, different forms of indicating markers such as number indicating markers, symbol indicating markers and pattern indicating markers could be conventionally replaced by replacement of the outer coverings. Alternatively, the outer coverings can be mounted on the outside of the combination disks by several different detachable manners such as coupling detachable manner, fitting detachable manner or engaging detachable manner.

### BRIEF DESCRIPTION OF THE DRAWINGS

The structure and the technical means adopted by the present invention to achieve the above and other objectives can be best understood by referring to the following detailed description of the preferred embodiments and the accompanying drawings.

FIG. 1 is a stereoscopic view showing a combination lock according to an embodiment of the present invention.

FIG. 2 is a schematic exploded view showing a lock body and a central slider of the combination lock according to the embodiment of the present invention.

FIG. 3a is a schematic plan view showing an outer covering and a combination assembly of the combination lock according to the embodiment of the present invention.

FIG. 3b is another schematic plan view showing the outer covering and the combination assembly of the combination lock according to the embodiment of the present invention.

FIG. 4 is a schematic cross-sectional view showing the central slider sliding through a fixing wheel of the combination lock according to the embodiment of the present invention.

FIG. 5 is a schematic plan view showing a fixing wheel and a spring of the combination lock according to the embodiment of the present invention.

FIG. 6 is a schematic plan view showing the outer covering detached from the outer wheel of the combination lock according to the embodiment of the present invention.

FIG. 7a is a schematic view showing the combination lock in a locking state according to the embodiment of the present invention.

FIG. 7b is a schematic view showing the combination lock in an unlocking state according to the embodiment of the present invention.

FIG. 8 is a schematic view showing a conventional combination lock in a prior art.

### DETAILED DESCRIPTION OF THE PREFERRED EMBODIMENTS

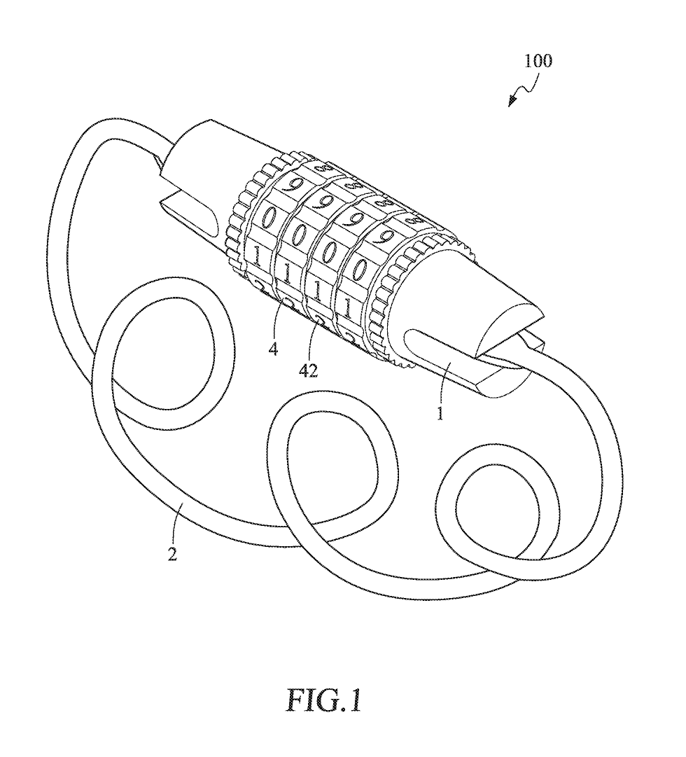

The preferred embodiments of the present invention are described in detail below with reference to FIG. 1 to FIG. 7b. The description is used for explaining the embodiments of the present invention only, but not for limiting the scope of the claims.

As shown in FIG. 1 to FIG. 7b, a combination lock according to an embodiment of the present invention includes a lock body 1, a shackle 2, a combination assembly and a plurality of outer coverings 4.

As shown in FIG. 1 to FIG. 7b, the shackle is removably connected to the lock body 1, the combination assembly is assembled to move in relation to the lock body 1, the combination assembly includes a central slider 31 and a plurality of combination disks. The central slider 31 is provided with a plurality of limiting teeth 311 protruding axially outward, and the central slider 31 is moved away from the lock body 1 to lock the shackle 2 or being gotten close to the lock body 1 to unlock the shackle 2. The plurality of combination disks are rotatable about and coaxially arranged on the central slider 31 to determine whether the central slider 31 is allowed to be moved to an unlocking position from a locking position such that locking or unlocking of the central slider 31 is controlled according to a rotation position of the combination disks.

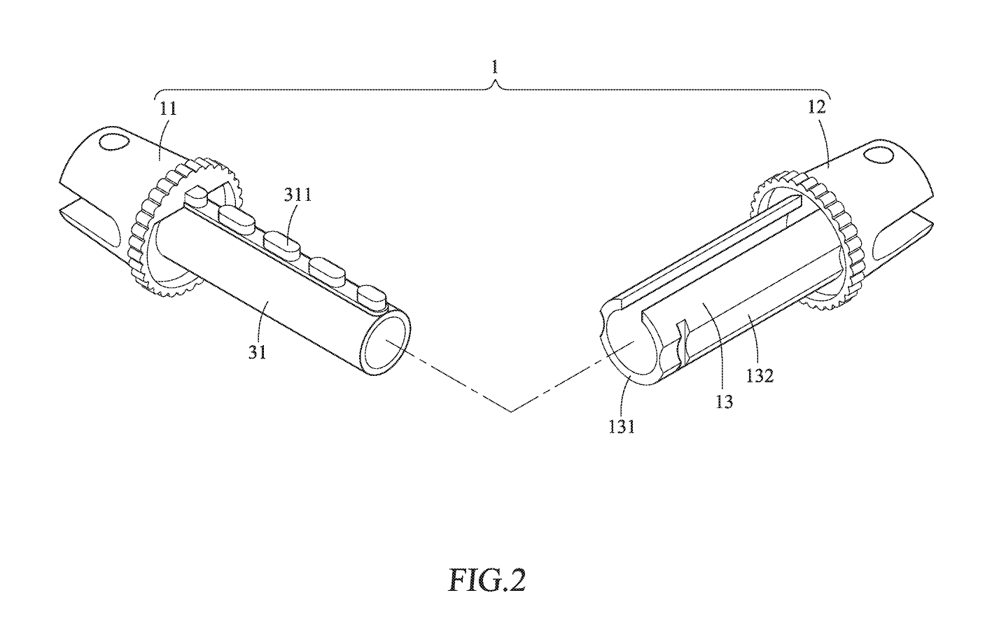

As shown in FIG. 2, the lock body 1 includes a front cap 11 and a rear cap 12, the front cap 11 is allocated in a backward direction along a longitudinal axis of the central slider 31 in relation to the central slider 31 to connect with the central slider 31, the rear cap 12 is allocated in a forward direction along the longitudinal axis of the central slider 31 in relation to the central slider 31 to form a sleeve body 13 having a sleeve 131, the sleeve body 13 is extended from the rear cap 12, and the sleeve 131 is corresponding to the central slider 31, wherein the central slider 31 slides through the sleeve 131 along the longitudinal axis of the central slider 31 to enable the front cap 11 and the rear cap 12 to be assembled together. Moreover, as shown in FIG. 2, two external sides of the sleeve body 13, which are opposite to each other, are axially formed with a groove 132, respectively.

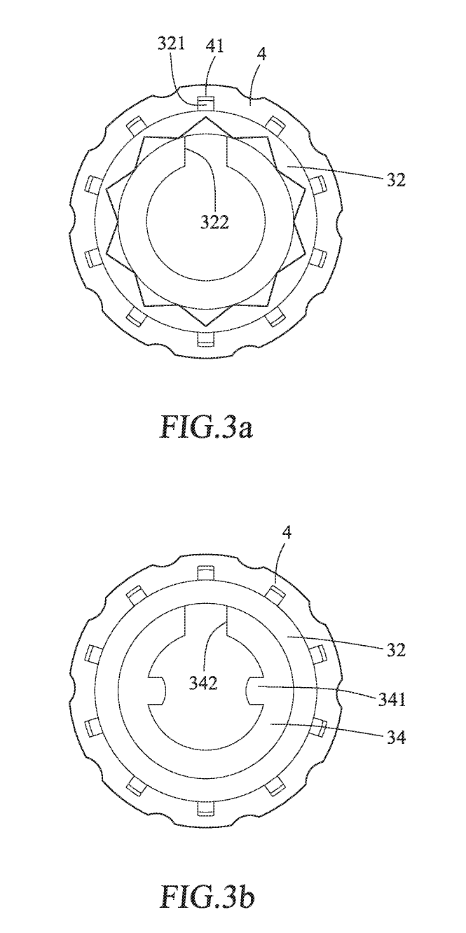

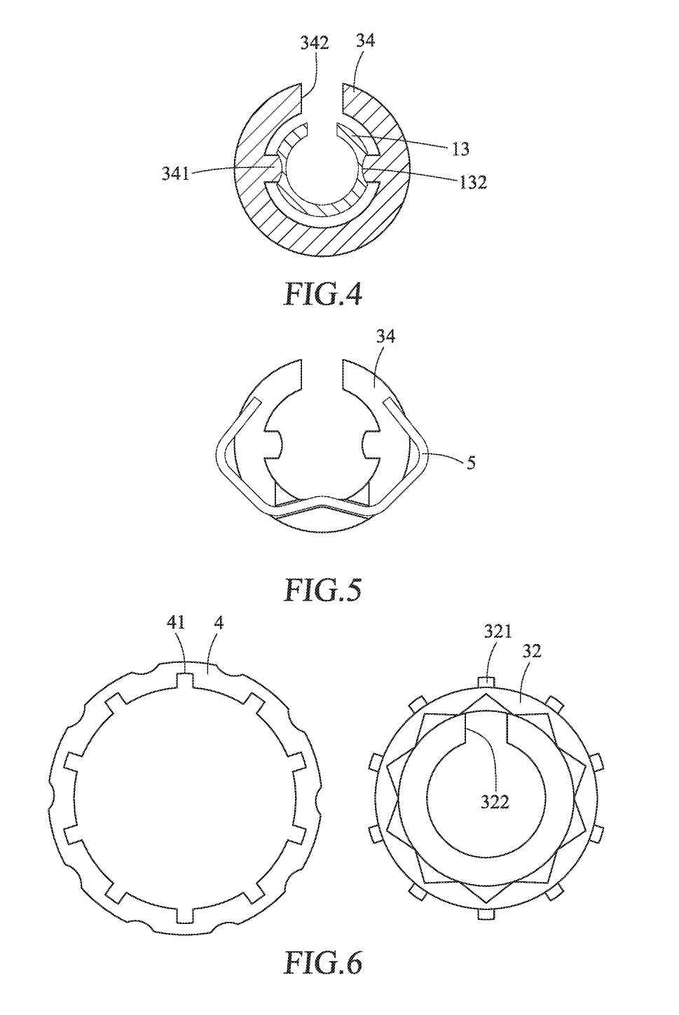

As shown in FIG. 3a and FIG. 3b, each combination disk includes a fixing wheel 34 and an outer wheel 32 which is provided to rotate around an outer periphery of the fixing wheel 34. Specifically, the outer wheel 32 and the fixing wheel 34 are substantially disk-shaped and have through holes. An external wall of the outer wheel 32 is formed with a plurality of external teeth 321, an internal wall of the outer wheel 32 is recessed outwardly to form a recess 322 corresponding to the limiting teeth 311. As shown in FIG. 4, the fixing wheel 34 is formed with a notch 342 having its position corresponding to the limiting teeth 311 and having its shape corresponding to the limiting teeth 311 such that the limiting teeth 311 slides through the notch 342 to enable the fixing wheel 34 to axially move on the central slider 31. An internal periphery of the fixing wheel 34 is formed with two convexes 341, each having its shape corresponding to the groove 132 and having its position corresponding to the groove 132, and the convex 341 is contacted to the groove 132 so as to limit a rotation of the fixing wheel 34 in relation to the central slider 31. It is worth mentioning that, as shown in FIG. 5, an internal surface of the fixing wheel 34 is provided with a spring 5 whose elastic force is used to provide effects of positioning during the outer wheel 32 rotating in relation to the fixing wheel 34.

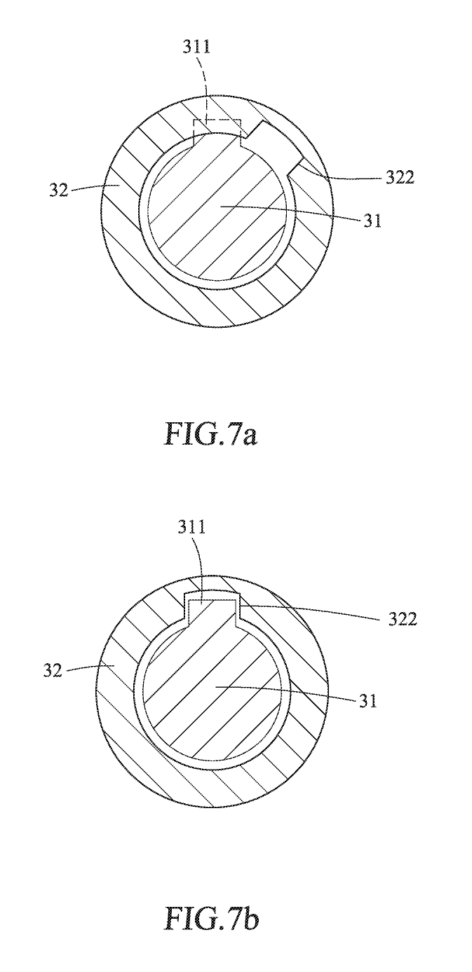

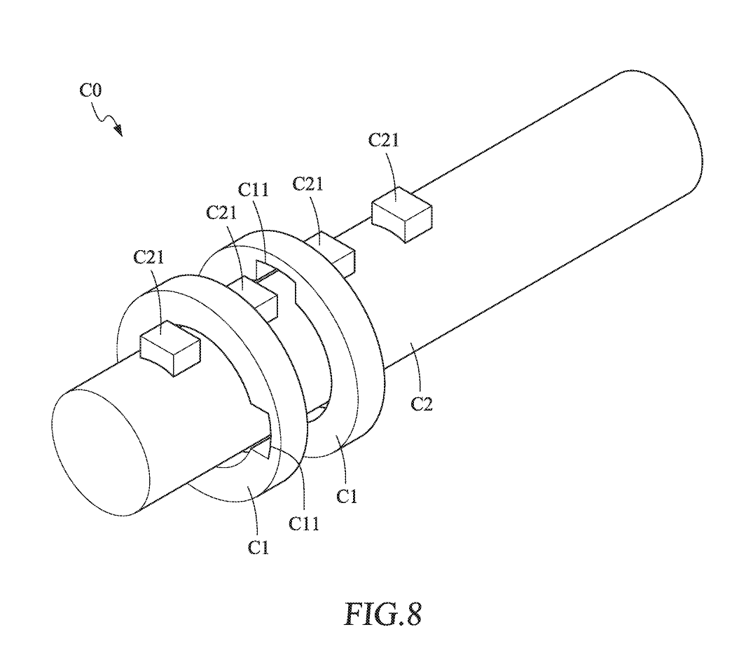

As shown in FIG. 1, FIG. 2, FIG. 3a and FIG. 7a, when the shackle 2 is locked to the lock body 1, the recess 322 of the outer wheel 32 is positioned in a horizontal plane different from the limiting teeth 311 of the central slider 31 so as to limit a movement of the central slider 31 by the outer wheel 32 blocking the limiting teeth 311.

As shown in FIG. 1, FIG. 2, FIG. 3b and FIG. 7b, when the shackle 2 is unlocked from the lock body 1, the recess 322 of the outer wheel 32 is positioned in the same horizontal plane as the limiting teeth 311 of the central slider 31 such that the central slider 31 is allowed to be moved to the unlocking position by the limiting teeth 311 moving through the recess 322 of each outer wheel 32.

As shown in FIG. 1, FIG. 3a and FIG. 6, the plurality of outer coverings 4 are detachably mounted on external surfaces of the plurality of combination disks 32 respectively. Specifically, the outer covering 4 is a ring body and is provided to rotate around the external surface of the outer wheel 32. An internal wall of each outer covering 4 is formed with a plurality of slots 41 corresponding to the plurality of external teeth and an outer surface of each outer covering 4 is covered with an indicating marker 42.

As shown in FIG. 6, each slot 41 is recessed outward from the internal wall of the outer covering 4. The outer covering 4 is mounted on the outer wheel 32 such that the plurality of slots 41 engage the plurality of external teeth 321.

As shown in FIG. 1, in this embodiment, the indicating marker 42 of the outer covering 4 is a number indicating marker. However, the present invention is not limited to this, and in other embodiment, the indicating marker 42 of the outer covering 4 may be a symbol indicating marker having a star pattern, a moon pattern, a flower pattern and the like. Preferably, the indicating marker 42 may have a combination of a number pattern and a symbol pattern.

In the combination lock 100 according to the present invention, the outer coverings 4 are configured to be able to be detached from the outer wheels 32 of the combination assembly and be replaced by any other kinds of outer coverings having different indicating markers such that the combination can be easily designed by using a variety of patterns.

The above description is only an explanation of the preferred embodiments of the present invention. One having ordinary skill in the art can make various modifications according to the above description and the claims defined below. However, those modifications shall still fall within the scope of the present invention.

What is claimed is:

1. A combination lock comprising:
a lock body;
a shackle, removably connected to the lock body;
a combination assembly being assembled to move in relation to the lock body, the combination assembly including a central slider and a plurality of combination disks, the central slider being moved away from the lock body to lock the shackle or being gotten close to the lock body to unlock the shackle, the plurality of combination disks being rotatable about and coaxially arranged on the central slider to determine whether the central slider is allowed to be moved to an unlocking position from a locking position such that locking or unlocking of the central slider is controlled according to a rotation position of the combination disks; and
a plurality of outer coverings being detachably mounted on external surfaces of the plurality of combination disks respectively, an outer surface of each outer covering being covered with an indicating marker,
wherein the outer coverings are configured to be able to be detached from the external surfaces of the combination disks and be replaced by any other kinds of outer coverings having different indicating markers.

2. The combination lock as claimed in claim 1, wherein the outer covering is a ring body and is provided to rotate around the external surface of the combination disk.

3. The combination lock as claimed in claim 1, wherein each combination disk includes a fixing wheel and an outer wheel which is provided to rotate around an outer periphery of the fixing wheel.

4. The combination lock as claimed in claim 3, wherein an external wall of the outer wheel is formed with a plurality of external teeth, an internal wall of the outer covering is formed with a plurality of slots corresponding to the plurality of external teeth, and the plurality of external teeth being provided such that the outer covering is mounted on the outer wheel such that the outer covering engages the plurality of slots.

5. The combination lock as claimed in claim 1, wherein the lock body includes a front cap and a rear cap, the front cap being allocated in a backward direction along a longitudinal axis of the central slider in relation to the central slider to connect with the central slider, the rear cap being allocated in a forward direction along the longitudinal axis of the central slider in relation to the central slider to form a sleeve body having a sleeve, the sleeve body being extended from the rear cap, the sleeve is corresponding to the central slider, wherein the central slider slides through the sleeve along the longitudinal axis of the central slider to enable the front cap and the rear cap to be assembled together.

6. The combination lock as claimed in claim 5, wherein an external side of the sleeve body is axially formed with a groove, an internal periphery of the fixing wheel is formed with a convex having its shape corresponding to the groove and having its position corresponding to the groove, and the convex being contacted to the groove so as to limit a rotation of the fixing wheel in relation to the central slider.

7. The combination lock as claimed in claim 1, wherein the indicating marker of the outer covering includes a number indicating marker and/or a symbol indicating marker.
